(19) United States
(12) Patent Application Publication
(10) Pub. No.: US 2007/0008325 A1
(43) Pub. Date: Jan. 11, 2007

(54) Method and apparatus providing for high efficiency data capture for compression encoding

(76) Inventors: Barinder Singh Rai, Surrey (CA); Eric Jeffrey, Richmond (CA)

Correspondence Address: EPSON RESEARCH AND DEVELOPMENT INC;INTELLECTUAL PROPERTY DEPT, 2580 ORCHARD PARKWAY, SUITE 225, SAN JOSE, CA, 95131, US

(21) Appl. No.: 11/177,836

(22) Filed: Jul. 8, 2005

(51) Int. Cl. G06T 1/00

(52) U.S. Cl. 345/501

(57) ABSTRACT

A preferred embodiment is directed to an image data processing unit providing for high efficiency data capture for compression encoding. In one embodiment, a control circuit is adapted to cause a data provider, such as a camera, to output pixel data in one of two modes. In a first mode, the data provider is caused to output pixel data in raster order. In a second mode, the data provider is caused to output pixel data in block order. The blocks have a y dimension and an x dimension. The y dimension is at least two data elements, and the x dimension is at least two and less than the a complete raster scan line of data elements. Another embodiment includes a memory remote from the data provider. The memory is for storing the pixel data output by the data provider in the second mode. The storage capacity of the memory is limited to substantially one of the blocks of pixel data in one embodiment. Preferably, a compression encoder for compression encoding the pixel data output by the data provider is provided.

### FIELD OF THE INVENTION

The present invention relates to a method and apparatus providing for high efficiency data capture for compression encoding and other forms of block data processing. More particularly, the invention relates to graphics display systems comprising a graphics controller for interfacing with a camera, which provides for high efficiency data capture for compression encoding.

### BACKGROUND

Graphics display systems, such as mobile or cellular telephones, typically employ a graphics controller as an interface between one or more providers of image data and a graphics display device, such as an LCD panel or panels. In a mobile telephone, the providers of image data are typically a host, such as a CPU, and a camera. The host and camera transmit image data to the graphics controller for ultimate display on the display device. The host also transmits control data to both the graphics controller and the camera to control the operation of these devices.

The graphics controller provides various processing options for processing image data received from the host and camera. For example, the graphics controller may compress or decompress, e.g., encode or decode according to the Joint Photographic Experts Group (“JPEG”) standard, incoming or outgoing image data, crop the image data, resize the image data, scale the image data, and color convert the image data according to one of a number of alternative color conversion schemes. All of these image processing functions provided by the graphics controller are responsive to and may be directed by control data provided by the host.

The host also transmits control data for controlling the camera to the graphics controller, the graphics controller in turn programming the camera to send one or more frames of image data acquired by the camera to the graphics controller. Where, as is most common, the graphics controller is a separate integrated circuit or “chip,” and the graphics controller, the host, and the camera are all remote from one another, instructions are provided to the camera, and image data from the camera are provided to the graphics controller for manipulation and ultimate display, through a camera interface in the graphics controller.

Cameras typically employ either charge-coupled-device (“CCD”) or complementary metal-oxide-semiconductor (“CMOS”) image sensor arrays. The CCD array is typically used in more expensive cameras and can provide very high image density and quality. However, due to inherent physical requirements, the CCD array must be read out in the manner of a “bucket brigade,” i.e., an entire line at a time, typically in raster scan order.

CMOS sensor arrays provide for lower power dissipation and more integration than CCD sensor arrays, and are often used in mobile telephones. The pixels in CMOS sensor arrays are individually addressable. However, the CMOS sensor array, like the CCD sensor, is also typically read out an entire line of pixels at a time in raster scan order.

Accordingly, the graphics controller typically includes a line buffer for receiving the respective lines of data output from the camera. The term “line” buffer is somewhat of a misnomer in that multiple lines of data are commonly stored in the line buffer. To provide for JPEG encoding of the data, at least eight lines must be stored in the line buffer, since JPEG encoding operates on 8×8 integral blocks of the data. Further, typically, at least sixteen lines are stored so that, at any given time, the graphics controller may be reading eight lines of data necessary for JPEG processing at the same time that eight new lines of data are being stored. This process is commonly referred to as “double buffering” or a “ping-pong” technique.

However, as there is always a need to reduce the number of memory storage and retrieval operations, to reduce power consumption as well as to reduce cost and increase processing bandwidth, there is a need, as the present inventors have recognized, for a method and apparatus providing for high efficiency data capture for compression encoding.

### SUMMARY

In a preferred embodiment, an image data processing unit providing for high efficiency data capture for compression encoding includes a control circuit. The control circuit is adapted to cause a data provider, such as a camera, to output pixel data in one of two modes. In a first mode, the data provider is caused to output pixel data in raster order. In a second mode, the data provider is caused to output pixel data in block order. The blocks have a y dimension and an x dimension. The y dimension is at least two data elements, and the x dimension is at least two and less than the a complete raster scan line of data elements. Another embodiment includes a memory remote from the data provider. The memory is for storing the pixel data output by the data provider in the second mode. The storage capacity of the memory is limited to substantially one of the blocks of pixel data in one embodiment, and to substantially two of the blocks of pixel data in another embodiment. In yet another embodiment, a compression encoder for compression encoding the pixel data output by the data provider is provided.

In another preferred embodiment providing for high efficiency data capture for compression encoding, a method for processing pixel data includes: (a) causing a data provider to output pixel data in raster order; and (b)in response to a signal, causing the data provider to discontinue outputting pixel data in raster order and to output pixel data in block order. The blocks have a y dimension and an x dimension. The y dimension is at least two data elements, and the x dimension is at least two data elements and less than a complete raster scan line of data elements. The method, in one embodiment, further includes a step of storing the blocks of pixel data output by the data provider in a memory remote from the data provider. The storage capacity of the memory is limited to substantially one of the output blocks of pixel data in one embodiment. In another embodiment, storage capacity of the memory is limited to substantially two of the output blocks of pixel data. In yet another embodiment, the method includes a step of compression encoding the output blocks of pixel data.

An alternative embodiment is directed to a program of instructions for performing a method which provides for high efficiency data capture for compression encoding. The program of instructions is preferably stored in a machine readable medium for execution by a machine. In one embodiment, the method includes: (a) causing a data provider to output pixel data in raster order; and (b) in response to a signal, causing the data provider to discontinue outputting pixel data in raster order and to output pixel data in block order. The blocks have a y dimension and an x dimension. The y dimension is at least two data elements, and the x dimension is at least two data elements and less than a complete raster scan line of data elements.

It is to be understood that this summary is provided as a means of generally determining what follows in the drawings and detailed description and is not intended to limit the scope of the invention. Objects, features and advantages of the invention will be readily understood upon consideration of the following detailed description taken in conjunction with the accompanying drawings.

### BRIEF DESCRIPTION OF THE DRAWINGS

FIG. 1 is a block diagram of a graphics display system providing for high efficiency data capture for compression encoding according to one embodiment of the present invention.

FIG. 2A is a schematic diagram illustrating receiving lines of pixels from an image data provider for data capture according to the prior art.

FIG. 2B is a schematic diagram illustrating receiving the image data of FIG. 2A in blocks of pixels according to one embodiment of the present invention.

### DETAILED DESCRIPTION OF PREFERRED EMBODIMENTS

The invention relates to a method and apparatus that provides high efficiency data capture for compression encoding. Preferred embodiments disclosed herein pertain more particularly to graphics display systems comprising a graphics controller for interfacing with a camera and providing for JPEG encoding. However, it should be understood that the principles described herein have wider applicability. In one preferred embodiment, the graphics display system is a mobile telephone, wherein the graphics controller is a separate integrated circuit or “chip” from the remaining elements of the system, but it should be understood that graphics controllers according to the invention may be used in other systems, and may be integrated into such systems as desired without departing from the principles of the invention.

Reference will now be made in detail to specific preferred embodiments of the invention, examples of which are illustrated in the accompanying drawings. Wherever possible, the same reference numbers are used in the drawings and the description to refer to the same or like parts.

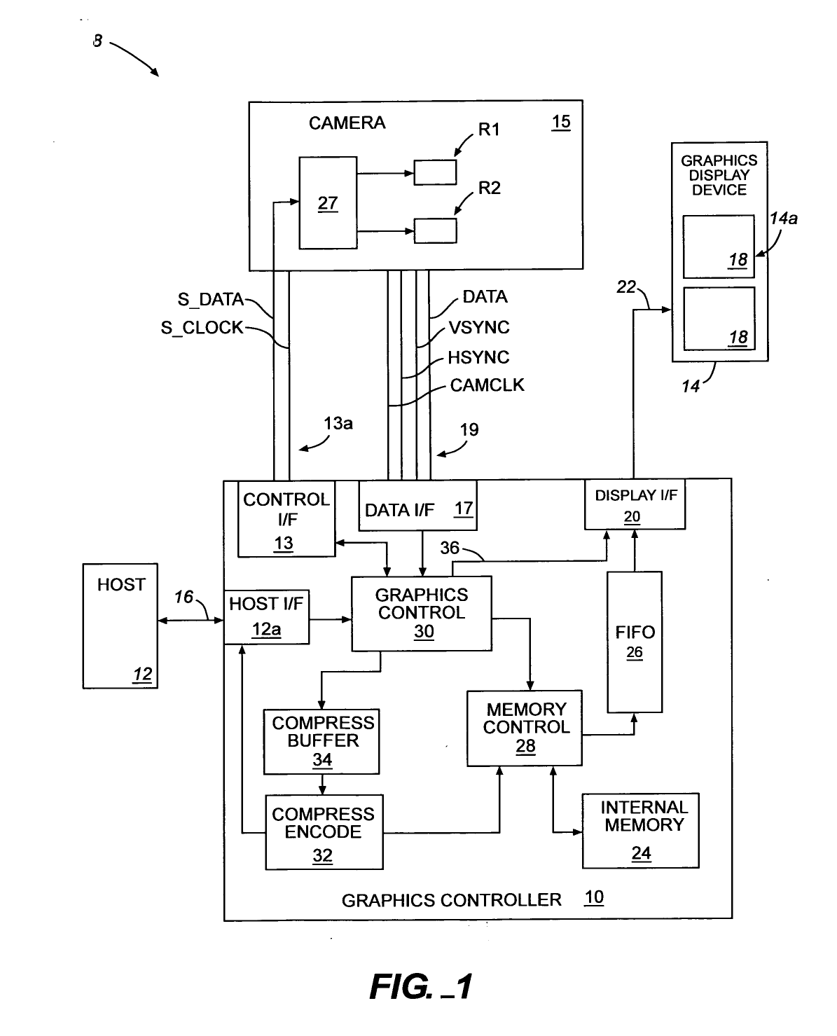

Referring to FIG. 1, a system 8 including a graphics controller 10 according to one preferred embodiment of the invention is shown. The system 8 may be any digital system or appliance providing graphics output; where it is a portable appliance such as a mobile telephone, a personal digital assistant, a digital camera, or a portable media player, it is powered by a battery (not shown). The system 8 preferably includes a host 12, a graphics display device 14, and one or more camera modules 15. The graphics controller 10 interfaces the host and cameras with the display device. As mentioned above, the graphics controller is typically and preferably separate (or remote) from the host, camera, and display device.

The host 12 is typically a microprocessor, but may be a digital signal processor, computer, or any other type of controlling device adapted for controlling digital circuits. The host communicates with the graphics controller 10 over a bus 16 to a host interface 12a in the graphics controller 10.

The display device 14 has one or more display panels 14a with corresponding display areas 18. The one or more display panels 14a are adapted for displaying on their display areas pixels of image data. LCDs are typically used as display devices in mobile telephones, but any device(s) capable of rendering pixel data in visually perceivable form may be employed. The graphics controller includes a display device interface 20 for interfacing between the graphics controller and the display device over a display device bus 22.

The camera 15 acquires pixel data and provides the pixel data to the graphics controller 10, in addition to any pixel data provided by the host 12. The camera is programmatically controlled through a “control” interface 13 which provides for transmitting control data (“S_Data”) to and from the camera and a clock signal (“S_Clock”) for clocking the control data. A serial bus 13a serving the interface 13 is preferably that known in the art as and inter-IC or I²C bus. The graphics controller 10 also has a parallel “data” interface 17 for receiving pixel data output over a plurality of DATA lines of a bus 19 from the camera 15 along with vertical and horizontal synchronizing signals (“VSYNC” and “HSYNC”), and a camera clocking signal CAMCLK for clocking the pixel data.

Often, the image data are output from the camera 15 in the YUV color format, where “Y” relates to the luminance value of the data, and “U” and “V” relate to chrominance values of the data. Display devices typically require image data in an RGB (red, green, blue) color format. The camera 15 may include a color converter and output image data in the RGB format.

The graphics controller 10 typically provides a number of data processing operations. For example, where the camera outputs YUV data, the graphics controller may convert YUV image data into the RGB color format. Color conversion can be performed on a pixel-by-pixel basis. Cropping and resizing operations are other data processing operations that may be performed by the graphics controller, and which can also be performed on a pixel-by-pixel basis. However, other types of operations require operating on sets or blocks of pixels. Most notably, JPEG encoding or decoding (referred to generally herein as “compression encoding”) operates on 8×8 blocks of pixels, or pixel components.

Image data (hereinafter “pixel data”) for use with the invention are preferably 24 bit sets of three 8-bit color components in the RGB color models. Pixel data elements for use with the invention, however, may have any other digital (numerical) range of bits for defining a component. Further, pixel data for use with the invention may be in any color format and may have any number of components, including a gray scale format having a single component. The phrase “pixel data” is used herein to refer to all of the components necessary to define a pixel, or one or more of the individual components, or both. One skilled in the art will appreciate from the context whether the phrase refers to all, or less than all of the necessary components, or both. For example, pixel data may refer to the individual Y, U, and V luminance components of YUV image data (or all of them) with reference to compression encoding. Similarly, pixel data may refer to the individual R, G, and B data elements of RGB pixel data (or all of the data elements) with reference to compression encoding.

As mentioned, JPEG encoding operates on 8×8 blocks of pixels, or pixel components. Accordingly, to obtain enough data to commence compression encoding of the image data, typically a minimum of eight full raster scan lines of pixel data are required. As also mentioned, graphics controllers typically include a line buffer for storing multiple lines of data. Blocks of 64 pixels (8×8) are fetched from the line buffer and fed to the compression encoder.

When CCD sensor arrays are employed, the data must be output from CCD sensors line by line. However, typical mobile telephones employ CMOS sensor arrays, and individual pixel data can be obtained in any desired sequence and in any desired amount. The host may also provide pixel data for display with the same flexibility. The present invention is directed to such circumstances in which data are not physically required to be output by the image data provider on a strict line-by-line basis, as is the case for cameras employing CCD sensor arrays. The camera 15 is, therefore, preferably of the CMOS sensor array type.

According to a preferred embodiment of the invention, the graphics controller 10 provides for switching between two modes of data acquisition through the use of a graphics control circuit 30. In a first mode, a user views a sequence of frames of image data on a display. The user selects a desired image, perhaps composing the shot, focusing the lens, and so on. The second mode is initiated by a signal from the user, such pushing a button for “snapping” a photo. In response to the signal, the graphics controller enters the second mode in which the desired image is captured. Generally, the second mode will immediately follow the first mode, though this is not required. The first mode, for example, may be a video mode with 20-30 frames per second being captured by the camera. The images acquired by the camera in the first mode are typically of lower quality than the images captured in the second mode. For instance, the first mode images may be low resolution, cropped, or scaled, or all of these things. The image acquired by the camera in the second mode is typically high resolution image, suitable for display on a high resolution device, but which requires a large quantity of memory for image storage. For example, sensors having the dimensions 160×1200, 2304×1728, 2720×2040, and 3072×2048 require, respectively, 1.92 MB, 3.98 MB, 5.54 MB, and 6.29 MB of memory for storing an image captured at full resolution. Similarly, image data from sensors of this size requires large line buffers. For example, for storing eight full raster scan lines, these sensors require, respectively, 75 kB, 108 kB, 127 kB, and 144 kB line buffers. (The memory sizes in this paragraph assume 24 bpp.)

In the first mode, the control circuit 30 receives image data from either or both the camera 15 and the host 12 and passes the data to a memory controller 28 for storage in an internal memory 24. The memory controller 28 fetches the image data from the memory 24 as needed and transmits the data to the display device interface 20 through a first-in-first-out (“FIFO”) memory buffer 26. Alternatively, the control circuit 30 may be adapted to “stream” the data directly to the display device interface 20 (via line or bus 36) if, for example, the graphics display device includes an embedded frame buffer, or if the clock rate for the production of the image data matches the clock rate for displaying the data.

As mentioned, the graphics controller enters the “capture mode” in response to a signal. As one example, the user presses a particular button, the host recognizes that the button has been pressed and generates an internal signal which is transmitted to the graphics controller. In response to the signal, the graphics controller programs the camera to begin sending image data in raster order, and further programs the camera to start sending image data in block order, as explained in additional detail below.

In the second capture mode of the graphics controller 10, the graphics controller prepares data from the camera (or other image data provider) for storage in a memory 24, or for sending to another device over a communications channel, by compression encoding the data. The graphics control circuit 30 transmits received image data to a compression encoder 32 through a second memory (compression buffer 34). After being compression encoded, the data are transmitted, in one embodiment, to the memory controller 28 for storage in the internal memory 24.

As mentioned, prior art CMOS array cameras have the capability to output blocks of data that are not necessarily complete lines. In a typical camera module, four registers, namely row start, row end, column start, and column end, are used to specify a block. However, only two registers are necessary to specify a rectangular block, so for illustrative purposes, only two registers will be described herein, it being understood that values for the remaining registers can be easily computed. Particularly, FIG. 1 shows two exemplary registers R1 and R2 in the camera 15 used to specify a desired block of pixel data. The graphics controller 10 programs the registers R1 and R2 through the control interface 13 over the serial bus 13a.

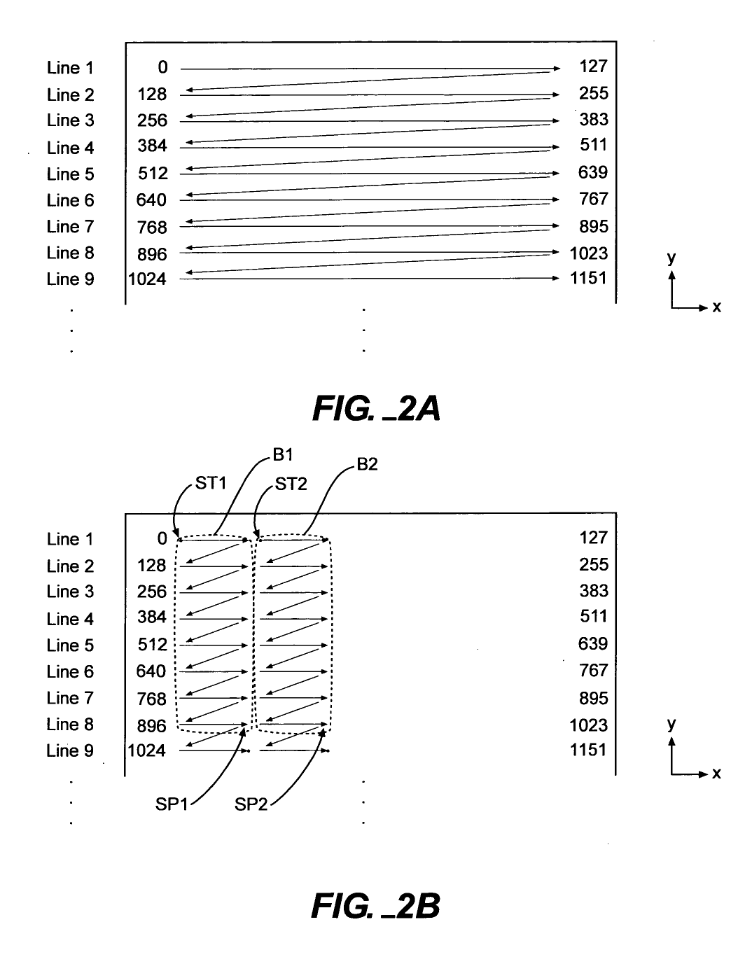

The registers R1 and R2 store, respectively, a starting address ST and a stopping address SP, where the addresses ST and SP are diagonally opposed corners of the desired block. Referring to FIG. 2A, assume for illustrative purposes that an image data provider produces an image having lines which are 128 pixels wide, i.e., scan lines having a linear (“x”) dimension of 128 pixels. In addition, assume that each successive pixel has a sequential address. In FIGS. 2A and 2B, the Line 1 addresses range from 0-127, the line 2 addresses range from 128-255, the line 3 addresses range from 256-383, the line 4 addresses range from 384-511, the line 5 addresses range from 512-639, the line 6 addresses range from 640-767, the line 7 addresses range from 768-895, the line 8 addresses range from 896-1023, and so on. It is desired to output 8×8 blocks of pixels, or pixel components, the blocks therefore have “x” and “y” dimensions that are each equal to 8, i.e., 8 pixels×8 lines. In the prior art, all eight of the lines Line 1—Line 8, each being 128 pixels wide, would be received from the camera 15 or other image data provider in raster scan order as shown in FIG. 2A before reaching the required “y” dimension of 8 lines.

Turning to FIG. 2B, according to one preferred embodiment of the capture mode of the present invention, it is noted that a start address ST1 of a first 8×8 pixel block B1 is 0 and a stop address SP1=896+7=903. Thereafter, a start address ST2 for an adjacent block B2 is the start address for the prior block ST1+8=ST2=8, and a stop address SP2=SP1+8=903+8=911, and so on. In capture mode, the graphics controller may, in one embodiment, repeatedly program the registers R1 and R2 for each new block over the serial bus 13a.

In another embodiment, the camera 15 or other image data provider is modified to sequence automatically through the blocks upon receipt of a “high-level” command from the graphics controller. When the graphics controller enters capture mode, it sends the high-level command to the camera. In this embodiment, the need for the graphics controller to repeatedly program the registers R1 and R2 for each new block is eliminated. For example, the graphics control circuit 30 may instruct a camera control circuit 27 resident in the camera 15 to cause the camera to output 8×8 blocks in a raster-like order, and the control circuit 27 would automatically increment initial values of the registers R1 and R2 by 8 each time. The circuit 27 may be adapted to receive the initial values of both R1 and R2, or of just one of the registers where the circuit computes R2=R1+7, or neither of the registers where the circuit is pre-programmed to start at R1=0.

As can be appreciated from the above description, the invention provides the outstanding advantage of providing for reduced storage demands and, therefore, reduced power consumption and increased processing bandwidth. As one example, a sensor outputting a 1600×1200 image requires a line buffer of 75 kB for storing 8 raster scan lines for compression encoding. According to one embodiment of the invention, an 8×8 block of pixel data is stored in the line buffer. This requires a mere 1.5 kB of storage. These advantages are particularly important in low-cost, battery powered consumer appliances such as mobile or cellular telephones.

When a data provider sends 8×8 blocks of 24 bpp pixel data, a 1.5 kB line buffer 34 is needed for storing the block for compression encoding. However, typically, the line buffer 34 is sized so that, at any given time, the compression encoding unit 32 may be reading one block of data necessary for JPEG processing while at the same time that another new block of data are being stored. Double buffering, however, while preferred, is not essential to the invention. Should the rate at which the encoding unit 32 processes data be sufficiently faster than the rate at which the camera 15 provides blocks of data, a buffer sized to store a single block of pixel data is all that is needed.

It should be understood that, while preferably implemented in hardware, the features and functionality described above may be implemented in a combination of hardware and software, or may be implemented in software, provided the graphics controller or the system is suitably adapted. For example, a program of instructions stored in a machine readable medium may be provided for execution in a processing device included in the graphics controller.

It is further to be understood that, while a specific method and apparatus providing for high efficiency data capture for compression encoding and other forms of block data processing has been shown and described as preferred, other configurations and methods could be utilized, in addition to those already mentioned, without departing from the principles of the invention.

The terms and expressions which have been employed in the foregoing specification are used therein as terms of description and not of limitation, and there is no intention in the use of such terms and expressions to exclude equivalents of the features shown and described or portions thereof, it being recognized that the scope of the invention is defined and limited only by the claims which follow.

1. An image data processing unit, comprising a control circuit adapted for causing a data provider to output pixel data in raster order in a first mode, and for causing the data provider to output pixel data in block order in a second mode, the blocks having a y dimension and an x dimension, wherein the y dimension is at least two data elements, and the x dimension is at least two and less than a complete raster scan line of data elements.

2. The processing unit of claim 1, further comprising a memory remote from the data provider for storing the pixel data output by the data provider in the second mode, wherein the storage capacity of the memory is limited to substantially one of the blocks of pixel data.

3. The processing unit of claim 2, further comprising a compression encoder for compression encoding the pixel data output by the data provider in the second mode.

4. The processing unit of claim 1, wherein the y dimension of the blocks is 8 data elements, and the x dimension is 8 data elements.

5. The processing unit of claim 4, further comprising a memory remote from the data provider for storing the pixel data output by the data provider in the second mode, wherein the memory is limited to substantially two of the blocks output by the data provider.

6. The processing unit of claim 5, further comprising a compression encoder for compression encoding the pixel data output by the data provider in the second mode.

7. The processing unit of claim 6, wherein the control circuit is further adapted for programming the data provider to output a particular block of pixel data.

8. The processing unit of claim 7, further comprising a graphics display controller.

9. A method for processing pixel data, comprising the steps of:
causing a data provider to output pixel data in raster order; and
in response to a signal, causing the data provider to discontinue outputting pixel data in raster order and to output pixel data in block order, the blocks having a y dimension and an x dimension, wherein the y dimension is at least two data elements, and the x dimension is at least two data elements and less than a complete raster scan line of data elements.

10. The method of claim 9, further comprising storing the blocks of pixel data output by the data provider in a memory remote from the data provider, wherein the storage capacity of the memory is limited to substantially one of the output blocks of pixel data.

11. The method of claim 10, further comprising compression encoding the blocks of pixel data.

12. The method of claim 9, wherein the y dimension is 8 data elements, and the x dimension is 8 data elements.

13. The method of claim 12, further comprising storing the blocks of pixel data output by the data provider in a memory remote from the data provider, wherein the storage capacity of the memory is limited to substantially two of the output blocks of pixel data.

14. The method of claim 13, further comprising compression encoding the output blocks of pixel data.

15. A graphics display system, comprising:
a host;
a display device;
an image data provider; and
a graphics controller having a control circuit adapted for selectably causing the image data provider to output pixel data in raster order, and in block order, the blocks having a y dimension and an x dimension, wherein the y dimension is at least two data elements, and the x dimension is at least two and less than the a complete raster scan line of data elements.

16. The graphics display system of claim 15, wherein the graphics controller further comprises a memory for storing the pixel data output by the image data provider, wherein the storage capacity of the memory is limited to substantially one of the blocks of pixel data.

17. The graphics display system of claim 16, wherein the image data provider includes a control circuit adapted to cause the image data provider to output 8×8 blocks of image data.

18. The graphics display system of claim 17, wherein image data provider includes a camera, and the graphics controller further comprises a compression encoder for compression encoding the pixel data output by the image data provider.

19. The graphics display system of claim 16, wherein the graphics controller further comprises a memory for storing the pixel data output by the image data provider, wherein the y dimension of the blocks is 8 data elements, and the x dimension is 8 data elements, and the memory is limited to substantially two of the blocks output by the image data provider.

20. The graphics display system of claim 19, wherein the graphics controller further comprises a compression encoder for compression encoding the pixel data output by the image data provider.
